(19) United States
(12) Patent Application Publication
(10) Pub. No.: US 2007/0156442 A1
(43) Pub. Date: Jul. 5, 2007

(54) RENTAL SYSTEM FOR TRAVEL KITS

(76) Inventor: Muhammad Safder Ali, Canton, MI (US)

Correspondence Address: Muhammad Safder Ali, 1281 Dundee Drive, Canton, MI, 48188-1288, US

(21) Appl. No.: 11/609,171

(22) Filed: Dec. 11, 2006

Related U.S. Application Data
(60) Provisional application No. 60/754,794, filed on Dec. 29, 2005.

(51) Int. Cl. G06Q 99/00

(52) U.S. Cl. 705/1

(57) ABSTRACT

A rental system for a travel kits is provided. The rental system includes providing a travel kit; establishing rental terms and charging a rental fee for the travel kit; and charging an additional fee if the travel kit is not returned in compliance with the rental terms. In an embodiment the additional fee may be a use fee or a purchase fee. The travel kit may include one or more items, including items that may be desirable under various conditions or circumstances.

### CROSS-REFERENCE TO RELATED APPLICATION

This application claims the benefit of U.S. Provisional Patent Application No. 60/754,794 filed on Dec. 29, 2005.

### TECHNICAL FIELD

The present invention relates generally to rentals kits, including a system for renting travel kits.

### BACKGROUND

Various forms of kits, including emergency kits and other forms of travel kits, are known in the art. However, such kits are not always readily available or are not made available on an as-needed basis to people that may only desire such kits for a limited duration or purpose such as, for example, travelers.

### SUMMARY

According to an aspect of the invention, a rental system for a travel kit is provided. The rental system includes providing a travel kit; establishing rental terms and charging a rental fee for the travel kit; and charging an additional fee if the travel kit is not returned in compliance with the rental terms. In an embodiment, the additional fee may be a purchase or use fee, as may be applicable. The travel kit may include one or more items, including items that may be desirable under various conditions or circumstances. As used herein, the term “charging” may mean the immediate charging of an amount or arranging for the payment of an amount, whether then or effectuated at a later time.

### BRIEF DESCRIPTION OF THE DRAWINGS

Embodiments of the invention will now be described, by way of example, with reference to the accompanying drawings, wherein:

FIG. 1 is a flowchart illustrating an embodiment of the inventive system;

FIG. 2 is a table that sets forth an example of items that may be included in an embodiment of a travel kit;

FIG. 3 is a table that sets forth an example of items that may be included in another embodiment of a travel kit;

FIG. 4 is a table that sets forth an example of items that may be included in yet another embodiment of a travel kit;

FIG. 5 is a table that sets forth an example of items that may be included in yet another embodiment of a travel kit; and

FIG. 6 is a table that sets forth a list of some sample items that could be provided by a roadside provider or contractor in connection with a roadside service event.

### DETAILED DESCRIPTION

Reference will now be made in detail to embodiments of the present invention, examples of which are described herein and illustrated in the accompanying drawings. While the invention will be described in conjunction with embodiments, it will be understood that they are not intended to limit the invention to these embodiments. On the contrary, the invention is intended to cover alternatives, modifications and equivalents, which may be included within the spirit and scope of the invention as defined by the appended claims.

The inventive system envisions, among other things, a system that involves the rental of various forms of travel kits that can be particularly suited for a number of conditions or circumstance. In an embodiment, the travel kits may comprise, for example and without limitation, emergency road kits and/or convenience kits, which may be rented or leased by travelers such as rental car customers.

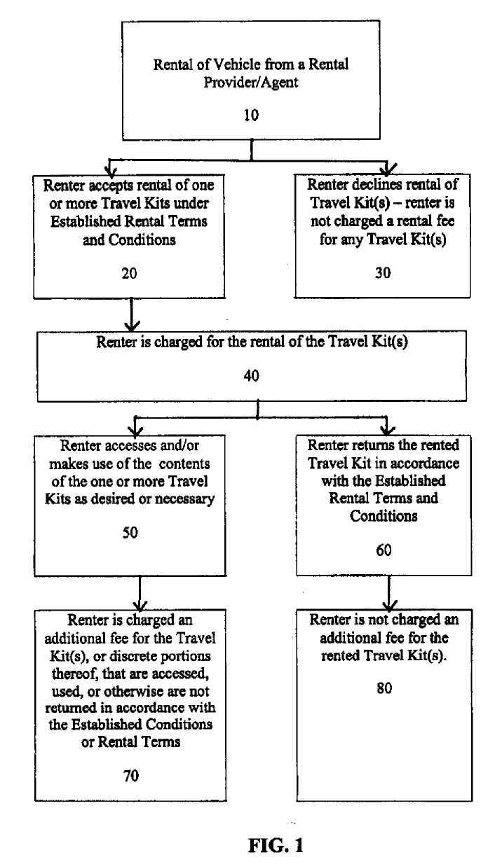

FIG. 1 illustrates a flow chart of an embodiment in a vehicle rental context. As illustrated, a customer can make arrangements for the rental or lease of a vehicle from a provider or rental agent (element 10). In connection with the rental transaction, either as part of the transaction involving the vehicle or as a separate and discrete transaction, the customer can be presented with an option to rent one or more travel kits. As discussed further herein, the kits may come in a wide variety of forms, with different adapted contents, for a variety of conditions or purposes.

The aforementioned customer has the option of accepting the rental of one or more travel kits (element 20) or declining the rental of such kit or kits (element 30). If the customer elects to rent one or more kits, such rental is typically covered under some form of accepted or established rental terms and conditions. For example, but without limitation, the terms and conditions associated with the rental of a travel kit may be included as part of the transaction involving the rental of a vehicle.

Customers that elect to rent one or more travel kits are then charged (element 40). In such case, a single manner of arranging for payment, e.g., a credit card charge authorization in connection with a written rental contract, could be used to handle both the vehicle and the travel kit aspects of the transaction. It is also contemplated that the rental of a travel kit could be handled entirely independently of the vehicle rental process and may, if desired, be arranged with or through a party unrelated to the rental of a vehicle.

Alternatively, the customer may chose to decline the rental of any travel kit. In which case, the customer would not receive a travel kit. That is the kit either not being provided to the customer in the first place or the kit being either physically removed from the vehicle or being rendered physically inaccessible to the customer. For example, one or more travel kits may be retained in a locked box or compartment on or associated with the vehicle. By way of example, but without limitation, the kit could be retained in compartment in the trunk of an automobile, such that the compartment can only be opened by or in connection with a key, a code, or other form or means of authorized and/or controlled entry. In cases in which the customer declines the rental, the customer will not incur or be charged a rental fee.

However, in cases in which one or more travel kits are retained in connection with the vehicle, but are not initially leased or rented, it is possible for the customer to agree as part of the rental agreement or otherwise, that, in the event the customer later finds themselves needing or wanting access to a kit, the customer will be charged a fee (possibly at a premium) for being permitted access to the kit. For example, the customer may be able to gain access to a code, or the compartment may be provided with a remote signal for opening, that would permit the customer to access the compartment and the kit. Further, in some embodiments, the customer could be provided with a separate means for access to the compartment, much in the same manner as a hotel guest is provided with a separate key or pass code in connection with a mini-bar located in the guest room.

As generally illustrated (element 30), if a rental is initially intended, the customer or renter is charged a rental fee for the associated travel kit or kits. The accepted or agreed upon “charge” may be made at that time or, under some circumstances, may be effectuated later. The renter can then access or make use of the contents of the rented travel kit or kits as desired and/or when necessary (element 50). If the renter does access or use the contents of a kit, then, in accordance with an embodiment of the system, the renter will be charged a corresponding additional fee (which may be a use and/or purchase fee, as may be applicable) for all or portions of the kit that have been accessed, used, or have not otherwise been returned in accordance with the established terms and conditions—for example, kits that have not been returned by a pre-established time or in an acceptable condition for immediate re-lease (element 70). The corresponding associated additional fee (which may be a use and/or purchase fee, as applicable) for a travel kit may be included in an initial contract that is signed by the renter and/or may be printed on the travel kit(s) or may be included in a table or list associated with the rented kit or kits.

In some instances, as established by the rental provider or agent, the additional fee may take the form of a “use” fee in addition to or rather than a purchase fee. Such an option may be established based on logical market conditions. For example, a traveler renting a car might desire a blanket or a crowbar on an emergency basis, but may not wish to purchase, pack and keep such an item, particularly if the person would be required to pack such an item for a return flight. Therefore, for travel kits that include certain items, the rental provider/agent may, rather than force the purchase of the item and/or the entire contents of a given travel kit or sub-kit (as the case may be), permit the renter to pay a use fee for the item and/or the associated kit. Then such item may then be returned for re-rental and the rental provider or agent may charge an additional fee that, among other things, covers the cleaning, restocking, and/or repackaging of the item and/or the related travel kit or sub-kit. In other instances, in which the item are inexpensive, disposable or highly personal in nature, such as toiletry items, no “use” fee would be applicable and the renter will be deemed to have purchased the contents of the entire applicable travel kit or sub-kit.

Conversely, as generally illustrated, if the renter returns the rented travel kit or kits in accordance with the established terms and conditions (element 60), then no additional fee (whether for use and/or purchase, as the case may be) would be additionally charged (element 80).

Without limiting the scope of the invention, Table 1 below illustrates, by way of example, a possible rental schedule for a given travel kit.

TABLE 1

| Days | Time | | Day | Time | Flat Rate |
|---|---|---|---|---|---|
| 0 | 00:01 HRS | TO | 02 | 23:59 HRS | $0.99 |
| 3 | 00:01 HRS | TO | 06 | 23:59 HRS | $3.99 |
| 7 | 00:01 HRS | TO | 13 | 23:59 HRS | $6.99 |
| 14 | 00:01 HRS | TO | 20 | 23:59 HRS | $9.99 |

The numbers included in the schedule are for purposes of illustration only. The actual schedule breakdowns and fees can be set to meet the needs of a given market and/or to encourage utilization of the travel kits. Moreover, while a given kit might typically have a given retail price, the provider or agent providing for the rental of the kits may be able to obtain significant discounts associated with the purchase of a volume of kits, thereby increasing the potential profit of the provider/agent and/or making the rental rates more attractive to the potential renter.

Additionally, with travel kits, such as personal convenience kits, a customer might find it advantageous or desirable to simply rent a travel kit and then, if the customer does not find a convenient place to purchase some desirable personal items, simply use and/or purchase the desired travel kit. Such a situation could occur, for instance, in a situation where a traveler is precluded from flying on a commercial airplane with certain carry-on items, and then rents a vehicle to drive to a hotel late at night. Further by renting or leasing a travel kit, a renter may only be required to pay for a short temporal period of potential use and, in many case, may avoid needing to incur the purchase of potentially unnecessary items.

In another embodiment, a user may be initially provided with a travel kit (or a selection of various forms of kits) as a courtesy, and without an initial charge, but the provision of the kit(s) will still be subject to some form of agreed upon or established rental terms. By way of example and without limitation, a user may be provided with a courtesy travel kit (or kits) under circumstances in which either the user and/or the provider of the kit(s) agrees to pay a designated fee if the kit is used or otherwise is not returned in accordance with the associated “rental” terms—which may include some form of timing. Then, if such terms are not met or satisfied (e.g., the kit is not returned with a vehicle), the user and/or the provider, as the case may be based upon the initial arrangement, will be charged a fee associated with the supplied kit(s).

In an alternative embodiment of the invention, a party, such as an emergency road service provider, can provide or deliver a given kit or set of kits to a renter of a vehicle. While various arrangements are possible, a road service provider could, for instance, deliver a travel kit for a flat fee in addition to the additional fee (i.e., use and/or purchase fee, as may be applicable) associated with a given travel kit or set of kits containing desired contents.

In an embodiment of the invention, persons having road service or auto club memberships (such as a AAA membership) could be provided with an opportunity to sign up for, for a nominal fee, for an additional service in which a dispatched service provider would make one or more travel kits available to a member that has encountered a road service event and is seeking assistance. For example, a person with a vehicle with a dead battery might desire some conveniences in connection with their road side support. Such a person may be interested in personal convenience kit that could include, for instance, water or another type of beverage, a towel or wipes, a comb, a snack bar, a camera (e.g., a disposable camera) or the like. The road service or auto club could then, as per the arrangements with the member, consider the kit as part of the pre-arranged service or charge a pre-arranged use and/or purchase price (as the case may be established) for the travel kit, which may be automatically charged or later billed.

In an embodiment of the invention, a rental provider and/or agent providing the kits can include some fairly efficient form of intake with respect to the return of the travel kits. If the rental provider/agent is also involved with the rental of a vehicle, it can simply include a very fast return/in-take procedure. Such a procedure can, if desired and properly arranged, be a simple check procedure that is involved much in the same way that a renter of a vehicle is required to return a vehicle with a given amount of fuel. It is anticipated that if a rental provider or agent associated with the travel kits is successful, that such a party might require additional space to store such travel kits.

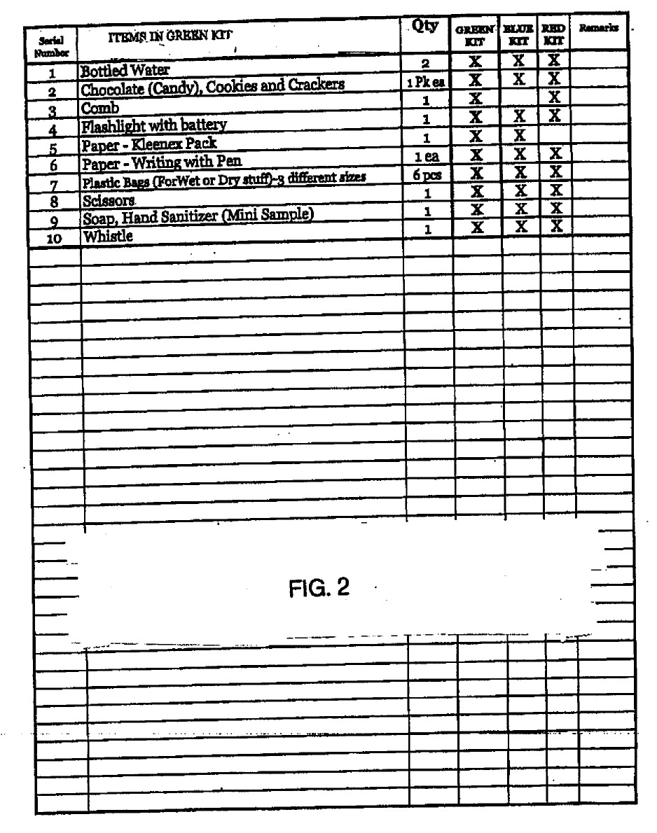

The travel kits associated with embodiments of the invention are not limited to any specific form or type of kit. Further, the contents of the available kit or kits thereof may be varied. FIG. 2 is a table that sets forth an example of items that may be included in connection with a “Green Kit” collection might take the form of a plastic container. Alternatively, the kit may be comprised of a different sturdy material or a flexible but sufficiently sturdy material. The primary kit might then include one or more kits or sub-kits that may include a different set of contents, and which may too, if desired, be color-coded (e.g., green, blue, red, etc.) to help make the system more efficient. Of course, the invention is not limited to the use of color-coding as a method of identification and other methods of numbering or identification may be used in addition to or in place of the color-coding discussed in connection with various embodiments of the invention. Moreover, “primary” kits may be appropriately sized for intended applications. For instance, the kits may be selected, configured, adapted, and/or sized for specific spaces, so as to better optimize the remaining storage space associated with the trunk or storage compartment of a given vehicle (e.g., model) or class of vehicles (e.g., compact car or SUV).

As shown in the example associated with FIG. 2, a renter might want to rent a smaller kit (for example, to save space) or may not have a desire or potential need for a specific item in a given travel kit. As such, the renter may be provided with different rental options and may, for instance, if the renter does not need or want facial wipes, may rent a lesser-cost kit or sub-kit, e.g., a “Red Kit” (which does not include that item).

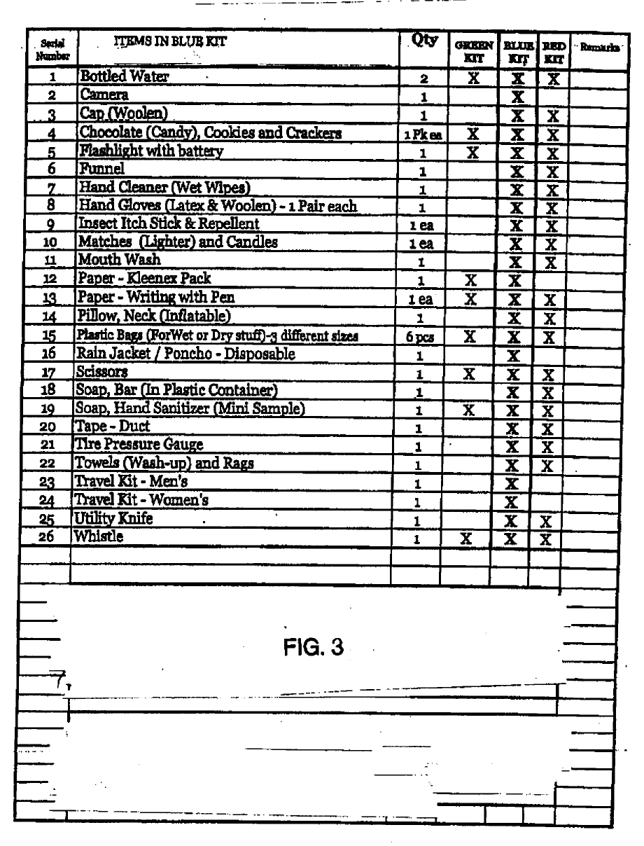

FIG. 3 is a table that sets forth other embodiments of various kits, which may also be distinguishable based upon a color-coded format. The kits or sub-kits associated with this example of items that may be included in connection with a “Blue Kit” collection might take the form of a plastic container. As with the previous example, the primary kit might then include one or more kits or sub-kits that may include a different set of contents, and which may too, if desired, be color-coded (e.g., green, blue, red, etc.) to help make the system more efficient. In this example, the kit or sub-kit, as the case may be, that is identified as a “Blue Kit” comprises all of the noted items, including a camera or digital recording device, which may be disposable and/or waterproof.

With respect to a camera or digital recording device, in instances in which a roadside service provider or contractor may be involved (such as previously mentioned), such a party may provide a camera or digital device or may handle the taking of photographs or recordation for the renter or member as part of the services arranged to be available or rendered. Moreover, the roadside service provider/contractor may, for instance, provide a set or requested number of nonprofessional pictures of a scene that will be made available to the renter/member. In an embodiment, the renter/member may be provided with a set of pictures in a digital medium or form, such as in a disk or a shipment as an electronic attachment. In another embodiment, the roadside provider/contractor may leave the pictures or digital recordings with a third party for processing in some form, the pictures or recordings then being made available for purchase and/or pick-up by the renter/member. As with the travel kits, the photography service may be handled on a rental and use-purchase basis.

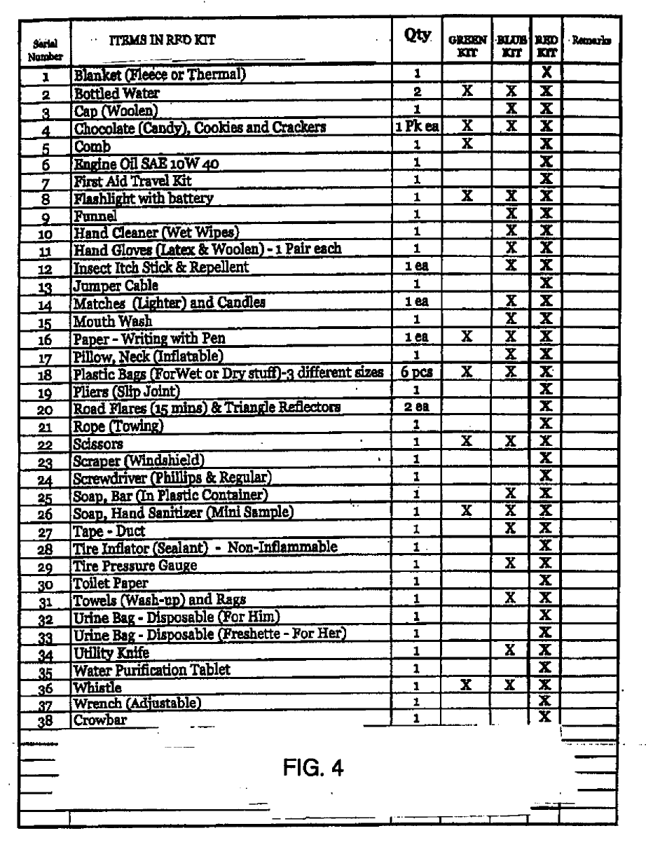

FIG. 4 is a table that sets forth other embodiments of various kits, which may also be distinguishable based upon a color-coded format. The kits or sub-kits associated with this example of items that may be included in connection with a “Red Kit” collection might take the form of a plastic container. As with the previous example, the primary kit might then include one or more kits or sub-kits that may include a different set of contents, and which may too, if desired, be color-coded (e.g., green, blue, red, etc.) to help make the system more efficient. In this example, the kit or sub-kit, as the case may be, that is identified as a “Red Kit” comprises all of the noted sample content items. In contrast, the associated “Green Kit” includes just a portion of the items included with the Red Kit from the Red Kit collection/container.

By way of example, and without limitation, if a renter rented the aforementioned “Red Kit” collection container, including Green, Blue, and Red sub-kits (with the contents as noted), and wanted the use of just a flashlight, the renter could access the Green Kit without incurring a greater charge associated with the other sub-kits. Similarly, if the user wanted to access and use a utility knife, the renter could access the Blue Kit and would not then need to purchase all of the additional items or contents associated with a comparatively more expensive Red Kit. Moreover, in an embodiment, a flashlight or other lighting device could be included with all available primary kits to, among other things, potentially reduce the checklist activity associated with returns.

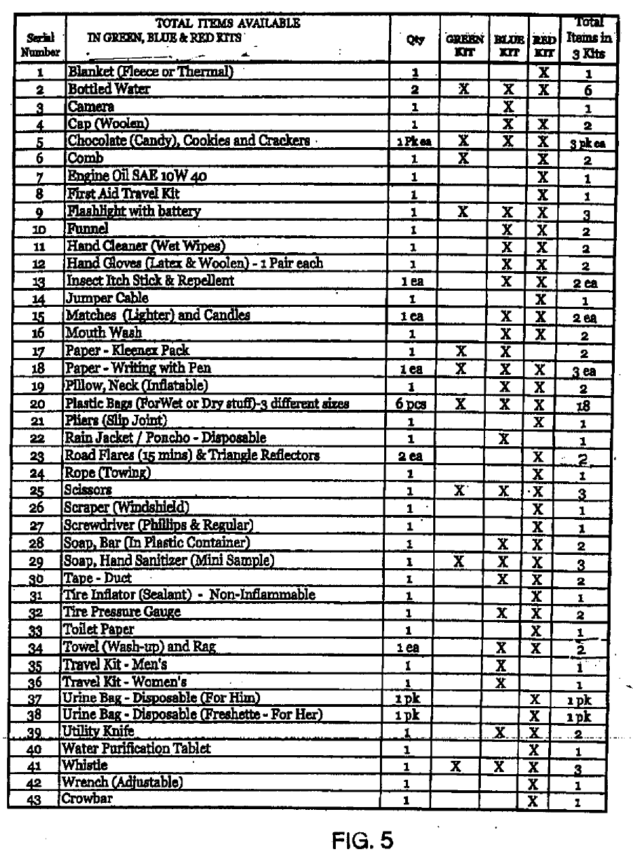

FIG. 5 is a table that sets forth other embodiments of various kits, which may also be distinguishable based upon a color-coded format. The kits or sub-kits associated with this example of items that may be included in connection with a more comprehensive collection of kits and/or containers that, as with preceding examples, may include one or more kits or sub-kits that may include a different set of contents, and which may too, if desired, be color-coded (e.g., green, blue, red, etc.).

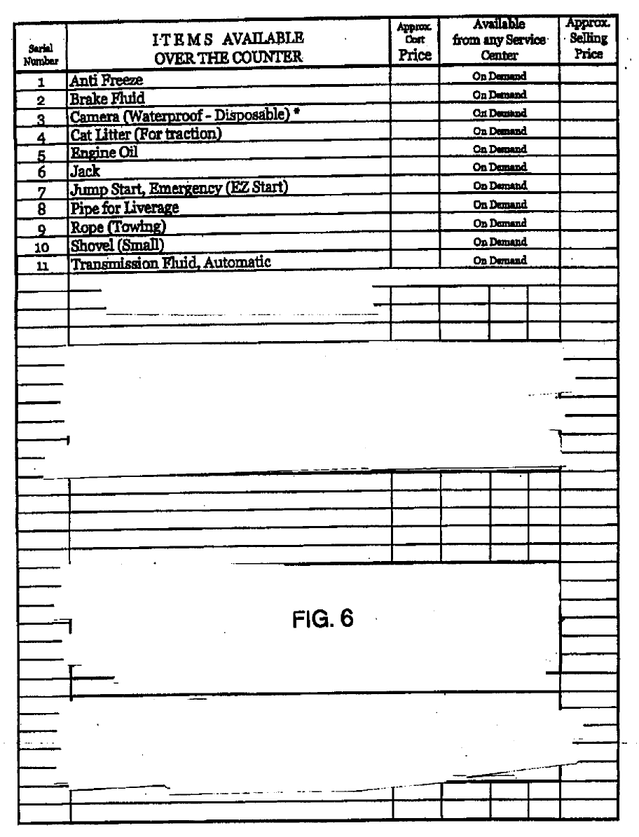

FIG. 6 is a table that sets forth a list of some sample items that could be provided by a roadside provider or contractor to a renter/member in connection with a roadside service event. Such a provider or contractor might maintain a minimum quantity of certain items. Such items might include items that not part of a travel kit and that are comparatively expensive or rarely used. In such an instance, a renter/member may only want the temporary use of such an item.

The kits, and sub-kits, as applicable, may take a variety of forms, and may include a wide variety of contents including emergency items, first aid items (which may include antacids, aspirin, or similar items), food and beverage items, and/or personal convenience items, including those listed in connection with the exemplary figures.

If desired, the kits may be clear, such that the contents are visible, or may include attached or associated listings or coding methods (e.g., color coding) that advise a user of the contents associated with a given kit. If desired a special, separate, or readily identified kit, such as one with a fluorescent marking, may be used for storage of a device such as a flashlight so that it can be more easily located under reduced lighting conditions. The kits may be packaged in a conventional manner, for example, without limitation, they may be shrink-wrapped; may include tabs that must be removed for access; or may employ a wide variety of tamper-evidencing technologies.

In some cases, for example where food items may be included within a kit, the associated kit or sub-kits may include tamper-evident features and may include certifications concerning the recommended or permitted shelf-life (e.g., date of expiration) for the associated items. Some examples of tamper-evident features include wrapping, tape, twist-locks, tabs, and other known conventional features and devices for confirming tampering or access.

In yet another embodiment, a travel kit may include a set of coins. In its smallest packaging, the kit may comprise a package for storing the coins Such coins may be used, for example and without limitation, for making telephone calls, paying tolls, feeding parking meters, or payment in connection with vending machines. If desired, such a kit may be configured for storage within a glove compartment or other small storage area of a vehicle that is more readily accessible to a vehicle occupant.

The foregoing descriptions of specific embodiments of the present invention have been presented for purposes of illustration and description. They are not intended to be exhaustive or to limit the invention to the precise forms disclosed, and various modifications and variations are possible in light of the above teaching. The embodiments were chosen and described in order to explain the principles of the invention and its practical application, to thereby enable others skilled in the art to utilize the invention and various embodiments with various modifications as are suited to the particular use contemplated. It is intended that the scope of the invention be defined by the claims appended hereto and their equivalents.

What is claimed is:

1. A rental system for a travel kit, the rental system comprising:
providing a travel kit, the travel kit including one or more items;
establishing rental terms and charging a rental fee for the travel kit; and
charging an additional fee if the travel kit is not returned in compliance with the rental terms.

2. The rental system according to claim 1, wherein the additional fee is charged if contents of the travel kit are missing, the travel kit is tampered with, or the travel kit is not returned.

3. The rental system according to claim 1, wherein the additional fee includes a purchase fee.

4. The rental system according to claim 1, wherein one or more items associated with the travel kit are returned and the additional fee includes a use fee.

5. The rental system according to claim 2, wherein the additional fee is charged automatically.

6. The rental system according to claim 5, wherein the additional fee is charged to a credit card number in accordance with the rental terms.

7. The rental system according to claim 1, wherein the travel kit includes a means for determining if the contents of the kit have been accessed or if there has been tampering with the travel kit or the packaging associated with the kit.

8. The rental system according to claim 1, wherein the travel kit includes a tamper-evident feature.

9. The rental system according to claim 1, wherein the contents of the travel kit are externally visible.

10. The rental system according to claim 1, wherein a list of contents of the travel kit is provided.

11. The rental system according to claim 1, wherein the travel kit includes at least a portion that is color-coded.

12. The rental system according to claim 1, wherein the travel kit is rented in connection with a transportation related event.

13. The rental system according to claim 12, wherein the transportation related event is the rental of a vehicle.

14. The rental system according to claim 13, wherein the travel kit is rented with the rental of the vehicle.

15. The rental system according to claim 1, wherein the travel kit includes two or more discretely-packaged sub-kits, each sub-kit including one or more items.

16. The rental system according to claim 15, wherein an additional fee is allocated for each discretely-packaged sub-kit and a user is charged with respect to each discretely-packaged sub-kit that is not returned in compliance with the established rental terms.

17. The rental system according to claim 15, wherein the contents of one or more sub-kits are externally visible.

18. The rental system according to claim 15, wherein a list of the contents of one or more sub-kits is provided.

19. The rental system according to claim 15, wherein at least a portion of one or more of the sub-kits are color-coded.

20. The rental system according to claim 1, wherein the travel kit includes one or more of the following: emergency road supplies, first aid supplies, or personal convenience items.

21. The rental system according to claim 1, wherein the travel kit includes a camera or digital recording device.

22. The rental system according to claim 1, wherein the travel kit includes one or more food or beverage items.

23. The rental system according to claim 1, wherein the travel kit includes a flashlight or illumination device.

24. The rental system according to claim 23, wherein the flashlight or illumination device is packaged in a travel kit having a means for identifying the kit under reduced lighting conditions.

25. The rental system according to claim 1, wherein the travel kit includes a coin or set of coins.

26. The rental system according to claim 1, wherein more than one travel kit may be selected for rental.

27. The rental system according to claim 1, wherein more than one travel kit may be rented.

28. The rental system according to claim 1, wherein the travel kit is provided in connection with the rental of a vehicle and is included in a compartment that includes a lock or other mechanism or device for controlled access or entry.

29. The rental system according to claim 28, wherein the user can be granted access to the compartment via a key, code, transmitted signal, or other authorized means for entry.

30. The rental system according to claim 1, wherein the travel kit or item associated with a travel kit are delivered by a road service provider or contractor.

31. The rental system according to claim 30, wherein the road service provider or contractor provides or delivers a camera or digital recording device to a scene.

32. The rental system according to claim 1, wherein the assessment of the return of a travel kit includes a travel kit return or intake procedure.

33. A rental system for a travel kit, the rental system comprising:
providing a travel kit, the travel kit including one or more items;
establishing rental terms and charging a rental fee for the travel kit; and
charging an additional fee if the travel kit is not returned in compliance with the rental terms;
wherein the travel kit includes a means for determining if the contents of the kit have been accessed or if there has been tampering with the travel kit or the packaging associated with the kit; the additional fee is charged if contents of the travel kit are missing, the travel kit is tampered with, or the travel kit is not returned; the additional fee includes a purchase fee, a use fee, or both a purchase and use fee; and wherein the additional fee is charged automatically.

34. A rental system for a travel kit, the rental system comprising:
providing a travel kit, the travel kit including one or more items;
providing a compartment for storing the travel kit, the compartment including a lock or other mechanism or device for controlling access to the travel kit;
establishing rental terms and charging a rental fee for the travel kit; and
charging an additional fee if the travel kit is not returned in compliance with the rental terms;
wherein the user can be granted access to the compartment via a key, code, transmitted signal, or other authorized means for entry.

35. The system according to claim 34, where access can be granted remotely from the compartment.

36. A rental system for a travel kit, the rental system comprising:
providing a travel kit, the travel kit including one or more items;
establishing rental terms for the travel kit with a user or a provider; and
as provided for by the rental terms, charging either the user or the provider of the travel kit an additional fee if the travel kit is not returned in compliance with the rental terms.
